(19) United States
(12) Patent Application Publication
(10) Pub. No.: US 2011/0314421 A1
(43) Pub. Date: Dec. 22, 2011

(54) Access to Touch Screens

(75) Inventors: Robert T. Arenburg, Round Rock, TX (US); Franck Barillaud, Austin, TX (US); Bradford L. Cobb, Cedar Park, TX (US); Shivnath Dutta, Round Rock, TX (US)

(73) Assignee: INTERNATIONAL BUSINESS MACHINES CORPORATION, Armonk, NY (US)

(21) Appl. No.: 12/818,490

(22) Filed: Jun. 18, 2010

(51) Int. Cl. G06F 3/048

(52) U.S. Cl. 715/823; 715/810

(57) ABSTRACT

A method for activating objects displayed on a touch screen by using a finger of a user. The method includes the steps of displaying one or more objects on the touch screen, detecting an activation event of a specific one of the one or more objects caused by the user touching the specific object, and displaying a first peripheral zone around the specific object. The peripheral zone contains a plurality of regions each for allowing the selection or activation of a function underlying the specific object by finger touch of the user.

### TECHNICAL FIELD

The invention relates to the field of touch screen navigation in general, and specifically to improving the ease of navigating, selecting and activating processes via a touch screen, especially as these features pertain to handheld devices such as cell phones, smart phones, personal digital assistants (“PDAs”), electronic book readers (“e-readers”), GPS devices, netbooks, and the like.

### BACKGROUND OF THE INVENTION

Applications on Cell Phones or PDAs are typically launched through icons. A normal use case, from a user standpoint, is to click on an icon to start the desired application. On a screen not having touch sensitivity, access to additional functions is usually provided by positioning the cursor on an icon and clicking on the right mouse button. For example, on a Windows machine, clicking the right mouse button while the cursor is over the ‘My Computer’ icon displays the ‘Open, Explore, Search, Manage, Map Network Drive. . . ’ and additional menu items that can be accessed. On large touch screen systems, this approach works well. On Cell Phone or PDA touch screens, a mouse is not usually available and the touch access method is not practical because of the size of the fingers compared to the size of the cursor. Differentiating between two menu items using a finger is much more difficult than doing it using a mouse cursor.

### SUMMARY OF THE INVENTION

A first embodiment is a method for activating objects displayed on a touch screen by using a finger of a user. The method includes the steps of displaying one or more objects on the touch screen, detecting an activation event of a specific one of the one or more objects caused by the user touching the specific object, and displaying a first peripheral zone around the specific object in response to detecting the activation event. The peripheral zone contains a plurality of regions each for allowing the activation of a function underlying the specific object by finger touch of the user.

A second embodiment is a computer-readable storage medium containing program code for controlling a handheld device to activate objects displayed on a touch screen by a finger of a user. The program code comprises code for displaying one or more objects on the touch screen, code for detecting an activation event of a specific one of the one or more objects caused by the user touching the specific object, and code for displaying a first peripheral zone around the specific object in response to the detection of the activation event. The peripheral zone contains a plurality of regions each for allowing the activation of a function underlying the specific object by finger touch of the user.

A third embodiment is a handheld device having a touch screen and containing program code for controlling the handheld device to activate objects displayed on the touch screen by a finger of a user. The program code comprises code for displaying one or more objects on the touch screen, code for detecting an activation event of a specific one of the one or more objects caused by the user touching the specific object, and code for displaying a first peripheral zone around the specific object in response to the detection of the activation event. The peripheral zone contains a plurality of regions each for allowing the activation of a function underlying the specific object by finger touch of the user.

The above as well as additional objects, features, and advantages of the present invention will become apparent in the following detailed written description.

### BRIEF DESCRIPTION OF THE DRAWING

The novel features characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 illustrates a typical touch screen handheld device with which the invention might be used;

FIGS. 2A, 2B and 2C show illustrative touch screen icon layouts using square or rounded-corner icons that might be used to practice the invention;

FIGS. 3A, 3B and 3C show an illustrative icon layout using circular icons; and

FIGS. 4, 5 and 6 contain illustrative flowcharts of a software engine that might be used to control the display and activation of touch screen icons and menu functions in accordance with the invention.

### DETAILED DESCRIPTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in an object oriented programming language such as Java, Smalltalk, “C++” or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

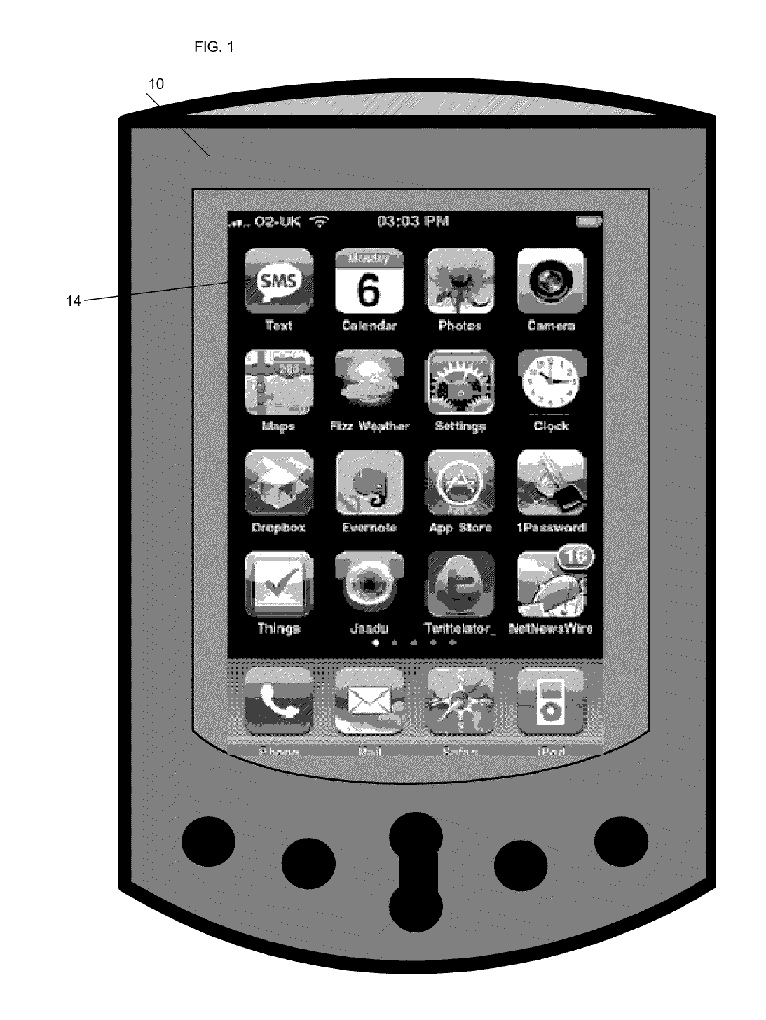

With reference now to the figures and in particular with reference to FIG. 1, there is depicted a typical handheld device containing a touch screen 10, which in turn displays a multitude of icons, such as icon 14 that refers to an application SMS. The user of the handheld 10 typically taps the icon with a finger to activate the SMS application and typically to then display a new set of menu functions related to SMS.

The invention displays these additional functions in a new way to ease their selection or activation of the additional underlying functions with a finger. The terms “select” and “activate” and their variations are used interchangeably through depending on context. Instead of listing functions in a popup window with each function listed as a menu item, the invention displays them in a form that is better aligned in terms of look and feel with what is already displayed on the screen. Most icons are represented as circles or rounded squares, although many other icon shapes might be used. The invention adds a peripheral zone in which additional underlying functions are depicted. The icon with the peripheral zone provides a natural path for a user to navigate by sliding and tapping within the peripheral zone to activate underlying functions. Using an approach where the additional functions are displayed around the icon makes selection and activation much easier than using a traditional popup listing approach or cascading rectangular menus.

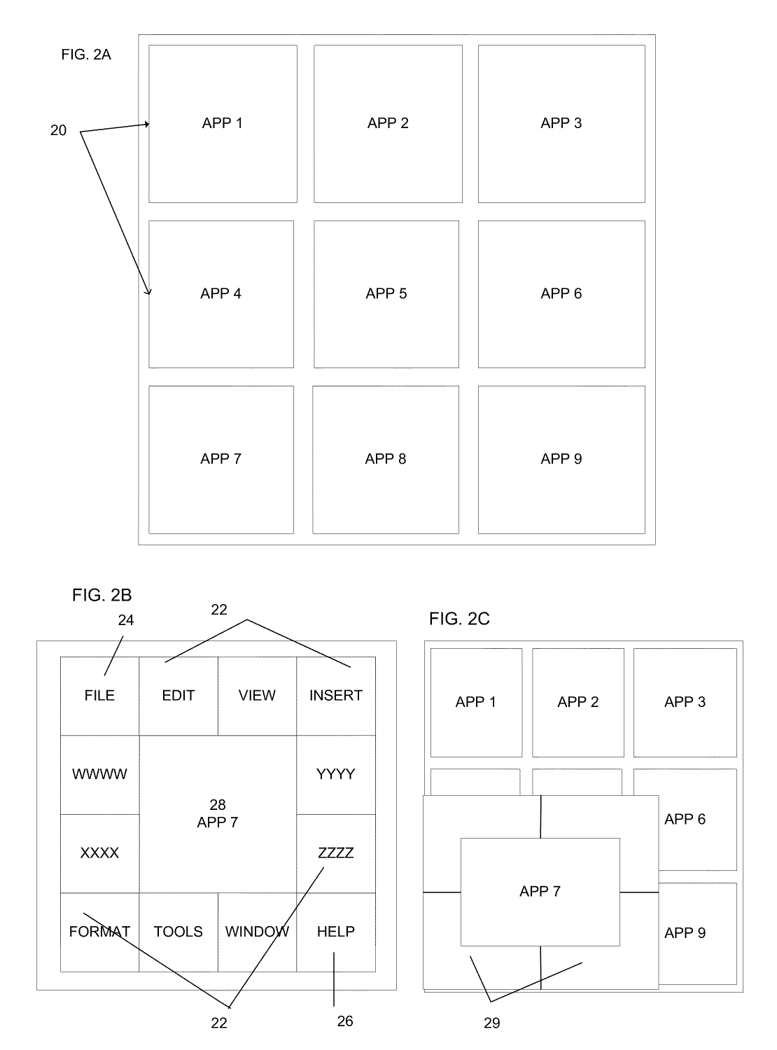

FIG. 2A shows another view of what corresponds to a touch screen 12 in FIG. 1, without a containing handheld for simplicity. This particular screen shows a three by three matrix of application icons 20 for applications APP 1 through APP 9. In one embodiment illustrated by FIG. 2B, when a user activates an icon for APP 7, for example, by single or double tapping of the APP 7 icon with a finger, the icon with peripheral zone fills essentially the full extent of the touch screen and includes the peripheral zone shown at 22. As briefly described above, the peripheral zone contains a number of additional underlying functions of APP 7, such as FILE 24 and HELP 26. The peripheral zone 22 provides an easy and natural way for a user to navigate with a finger the underlying functions of an APP icon and to activate a desired function. If a user changes his or her mind after selecting an APP icon, the user can easily return to the original screen by tapping the APP icon 28 in the middle of the icon. Of course, the peripheral zone need not totally surround a selected icon or object in all cases if not needed to adequately display underlying functions large enough to aid user selection and activation.

FIG. 2C illustrates a second embodiment in which a selected icon with peripheral zone consumes less that an entire touch screen. A choice of FIG. 2B or 2C might depend on the number of underlying functions 29 in the peripheral zone that are associated with an APP icon, for example.

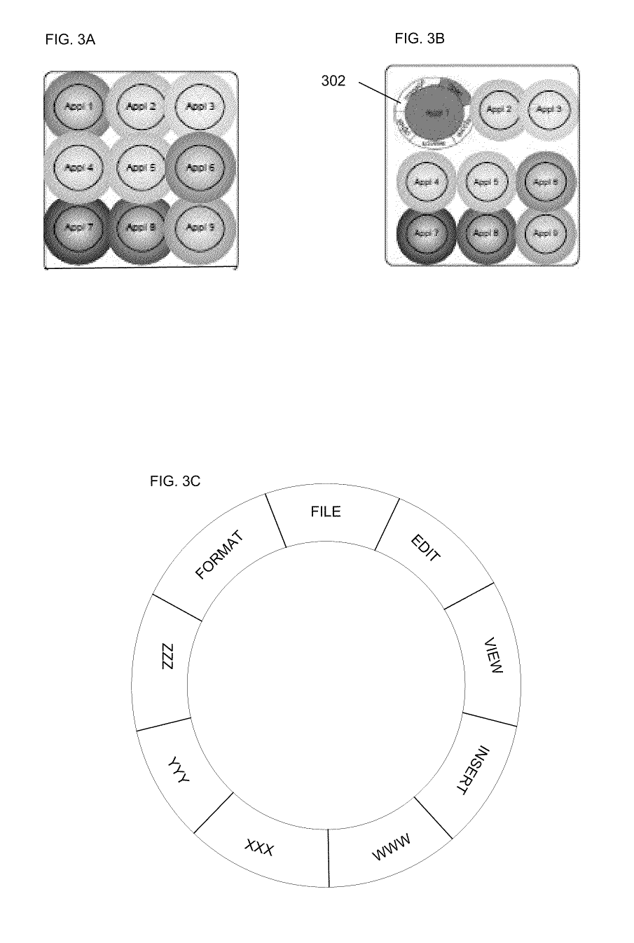

FIGS. 3A, 3B and 3C in the aggregate are illustrations of the concepts already discussed, but using circular icons rather than square icons. FIG. 3A shows an initial touch screen in which an icon has not been selected. FIG. 3B illustrates a selected circular icon in much the same way a square icon is selected as in FIG. 2C. This example of a selected circular icon still contains a peripheral zone 302 for displaying underlying functions.

FIG. 3C simply provides a larger view of a peripheral zone around a selected circular icon for clarity.

It is not intended to limit the invention to embodiments containing square or circular icons Almost every conceivable two-dimensional shape has the potential to be enhanced with a peripheral zone suitable for finger navigation; it is intended that the invention encompass such embodiments.

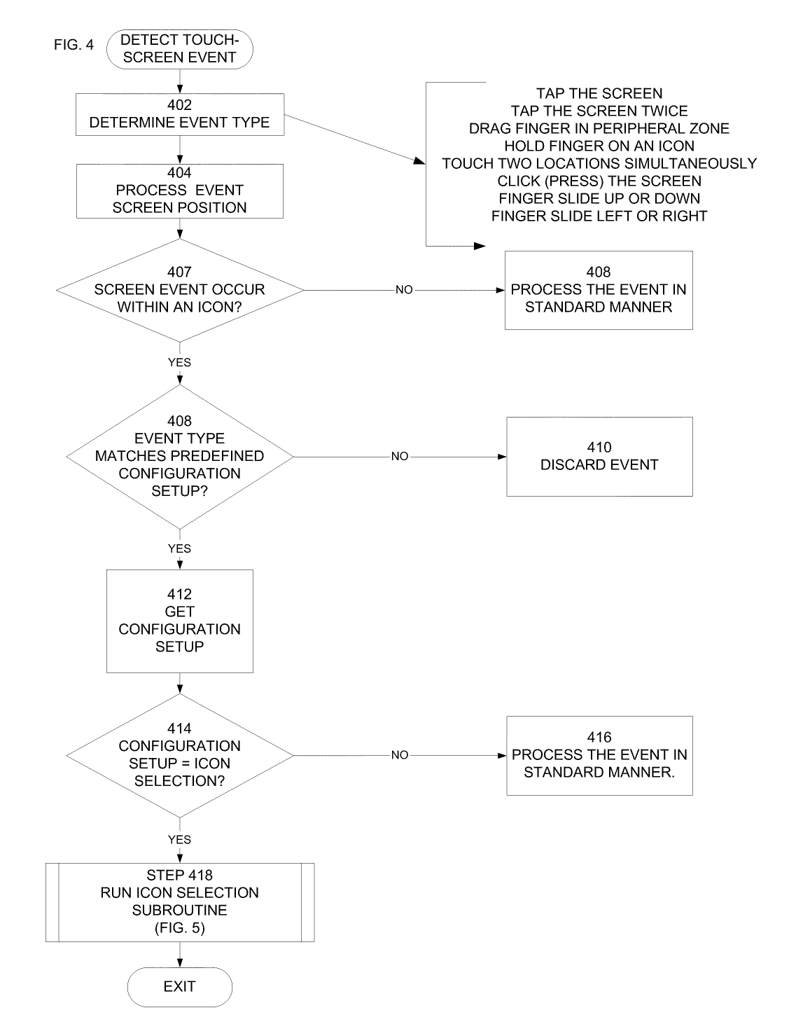

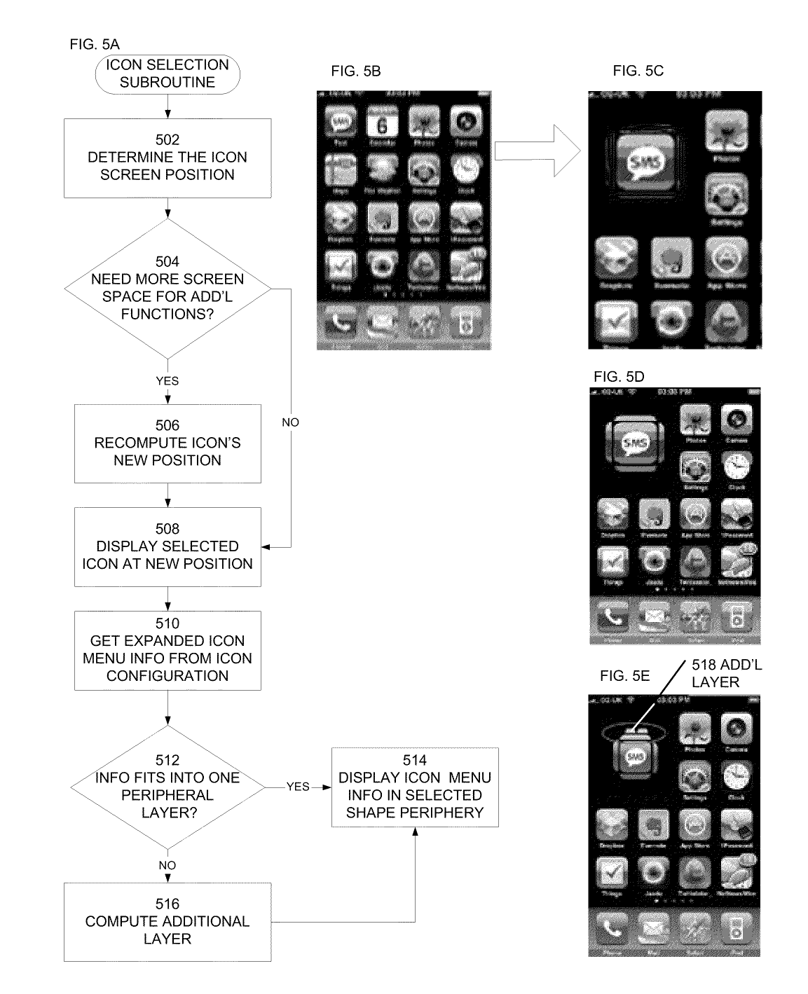

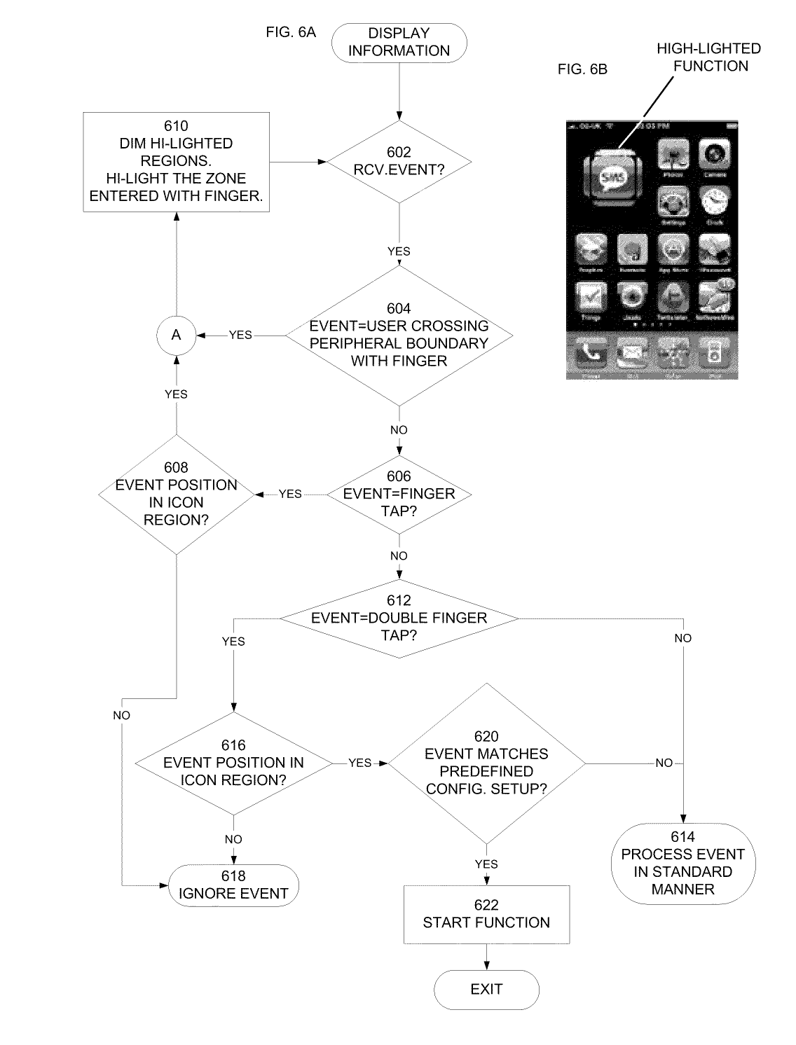

FIGS. 4 through 6 contain illustrative flowcharts that might be used to implement the invention. FIG. 4 illustrates the main flowchart in which a touch screen event message detected by an operating system of a handheld device is sent to a process associated with an active screen or window. This message receiving process of FIG. 4 first determines at step 402 the type of detected screen event that has been detected. An annotation to the right of step 402 lists a number screen events that are typically associated with a handheld device. Step 404 determines the screen position at which the event took place. If that position is not within an icon, step 408 transfers to a screen update process shown in FIG. 6 to process the event. If the event position is inside an icon, step 406 moves on to step 407 where the event type is used to determine if the event corresponds to a predefined configuration setup file. If the event does not correspond to a configuration setup file, the event is ignored by discarding the message at step 410. Otherwise, step 412 fetches the matching configuration setup file and step 414 determines from the file if the screen event calls for an icon expansion in accordance with the invention. If icon expansion is not specified by the configuration setup file, the screen event is processed in a standard manner at step 416. If icon expansion is required, step 418 places a call to an icon expansion subroutine illustrated in FIG. 5.

With reference now to FIG. 5, step 502 determines, or is given, the screen position of the icon that has been activated. Step 504 determines from the configuration setup file if the selected icon requires additional space to display underlying functions than the usual expansion algorithm. If so, step 506 computes a screen position for the selected icon. In any event, step 508 next displays the selected icon on the screen. FIG. 5B illustrates the screen as it might appear prior to selection and FIG. 5C illustrates the screen as it might appear after selection. The peripheral zone for underlying functions is not yet created. Step 510 gets additional information from the configuration setup file and step 512 determines if the underlying functions to be displayed in the peripheral zone requires additional layers of a peripheral zone. If an addition peripheral zone layer is not needed, step 514 creates the peripheral zone and displays the underlying functions. The screen then might appear as shown in FIG. 5D. If an additional layer is needed, step 516 computes its parameters and passes the information on to step 514 for creation. An example of an addition layer is shown at 518 of FIG. 5E. The process in FIG. 6A is then called at step 518 to update the screen information.

FIG. 6 illustrates a process that might be used to process screen events, including screen taps and screen navigation using fingers. Step 602 loops until a screen event message is received from an operating system. When an event message arrives, step 604 determines if the event represents a user navigating the screen by crossing a peripheral zone boundary by dragging a finger. If the answer is yes, then step 610 is entered where all peripheral zone functions are dimmed and then the function entered is high-lighted. This represents a typical function selection. FIG. 6B shows an illustration of a high-lighted function. If the event is not a peripheral zone boundary crossing at 604, then 606 looks for a finger tap of the screen. If that is the case, and the tap is in an icon or function region, then this action might also represent a screen selection and step 610 is performed to high-light the peripheral zone function. If the event is a double-tap at step 612 and the double-tap is in an icon or function region at step 616, then step 620 is performed to determine if the event is defined in the setup configuration file. Assuming that the event is defined, then step 622 activates the function that is defined in the configuration setup file. For all other screen event situations that might occur in this illustrative embodiment, the event is ignored. Obviously, many other screen events can be defined and processed in a similar manner as described.

It will be appreciated that the computer illustrated in FIG. 6 is merely illustrative, and is not meant to be limiting in terms of the type of system which may provide a suitable operating environment for practicing the present invention. While the computer system described in FIG. 6 is capable of executing the processes described herein, this computer system is simply one example of a computer system. Many systems are capable of performing the processes of the invention.

It should be clear that there are many ways that skilled artisans might use to accomplish the essential steps to implement an overall network solution, other that the specific steps and data structures described herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

I claim:

1. A method for activating objects displayed on a touch screen by using a finger of a user, comprising
displaying one or more objects on the touch screen,
detecting an activation event of a specific one of the one or more objects caused by the user touching the specific object, and
displaying a first peripheral zone around the activated specific object, the peripheral zone containing a plurality of regions each for allowing the activation of a function underlying the activated specific object by a finger touch of the user.

2. The method of claim 1 wherein the specific object with peripheral zone occupies essentially all of the touch screen.

3. The method of claim 1 wherein the specific object with peripheral zone occupies a portion of the touch screen.

4. The method of claim 1 further comprising the display of a second peripheral zone outside of the first peripheral zone to display additional underlying functions associated with the specific object.

5. The method of claim 1 further comprising detecting a crossing of a boundary of a region of the first peripheral zone by a finger of the user, and in response high-lighting the region that is entered by the finger.

6. The method of claim 1 further comprising detecting a finger tap within a region of the first peripheral zone by a user, and in response high-lighting the region that is tapped by the user.

7. The method of claim 1 or claim 4 wherein the screen objects comprise icons having a plurality of sides.

8. The method of claim 1 or claim 4 wherein the screen objects comprise icons having circular shapes.

9. A computer-readable storage medium comprising program code for controlling a handheld device to activate objects displayed on a touch screen by a finger of a user, the program code comprising
code for displaying one or more objects on the touch screen,
code for detecting an activation event of a specific one of the one or more objects caused by the user touching the specific object, and
code for displaying a first peripheral zone around the specific object, the peripheral zone containing a plurality of regions each for allowing the activation of a function underlying the specific object by finger touch of the user.

10. The storage medium of claim 9 wherein the code for displaying a first peripheral zone causes the object with first peripheral zone to occupy essentially all of the touch screen.

11. The storage medium of claim 9 wherein the code for displaying a first peripheral zone causes the object with first peripheral zone to occupy a portion of the touch screen.

12. The storage medium of claim 9 wherein the code for displaying the first peripheral zone further comprises code for displaying a second peripheral zone outside of the first peripheral zone to display additional underlying functions associated with the specific object.

13. The storage medium of claim 9 further comprising code for detecting a crossing of a boundary of a region of the first peripheral zone by a finger of the user, and in response high-lighting the region that is entered by the finger.

14. The storage medium of claim 9 further comprising code for detecting a finger tap within a region of the first peripheral zone by a user, and in response code for high-lighting the region that is tapped by the user.

15. The storage medium of claim 9 or claim 12 wherein the screen objects comprise icons having a plurality of sides.

16. The storage medium of claim 9 or claim 12 wherein the screen objects comprise icons having circular shapes.

17. A handheld device having a touch screen and containing program code for controlling the handheld device to activate objects displayed on the touch screen by a finger of a user, the program code comprising
code for displaying one or more objects on the touch screen,
code for detecting an activation event of a specific one of the one or more objects caused by the user touching the specific object, and
code for displaying a first peripheral zone around the specific object, the peripheral zone containing a plurality of regions each for allowing the activation of a function underlying the activated specific object by finger touch of the user.

18. The handheld device of claim 17 wherein the code for displaying a first peripheral zone around the specific object causes the specific object with peripheral zone to occupy essentially all of the touch screen.

19. The handheld device of claim 17 wherein the code for displaying a first peripheral zone around the specific object causes the specific object with peripheral zone to occupy a portion of the touch screen.

20. The handheld device of claim 17 wherein the code for displaying the first peripheral zone further comprises code for displaying a second peripheral zone outside of the first peripheral zone to display additional underlying functions associated with the specific object.

21. The handheld device of claim 17 further comprising code for detecting a crossing of a boundary of a region of the first peripheral zone by a finger of the user, and in response high-lighting the region that is entered by the finger.

22. The handheld device of claim 17 further comprising code for detecting a finger tap within a region of the first peripheral zone by a user, and in response code for high-lighting the region that is tapped by the user.

23. The handheld device of claim 17 or claim 20 wherein the screen objects comprise icons having a plurality of sides.

24. The handheld device of claim 17 or claim 20 wherein the screen objects comprise icons having circular shapes.

25. The handheld device of claim 17 further comprising code for activating the underlying function in response to a double tap of a user finger.
